(19) United States
(12) Patent Application Publication
(10) Pub. No.: US 2009/0044478 A1
(43) Pub. Date: Feb. 19, 2009

(54) Clamping Structure

(76) Inventor: Jones Yeh, Wayao Village (TW)

Correspondence Address: Dr. BANGER SHIA, 102 Lindencrest Ct., Sugar Land, TX, 77479-5201, US

(21) Appl. No.: 11/837,558

(22) Filed: Aug. 13, 2007

(51) Int. Cl. E06B 1/56

(52) U.S. Cl. 52/584.1

(57) ABSTRACT

A clamping structure comprises: a pressing seat fixed on a wall; a housing disposed at one side of the pressing seat, a receiving space being formed in the housing, an opening being defined in a side of the housing facing the pressing seat, a slope being defined in a corner of the receiving space and located under the opening; a clamping member being movably disposed in the receiving space of the housing and partially contacting the slope. When its own gravity acts, the clamping member will partially be exposed out of the opening to press a to-be-clamped object against the pressing seat, so that the object is fixed without falling off.

### BACKGROUND OF THE INVENTION

1. Field of the Invention

The present invention relates to a clamping structure, and more particularly to a simply structured and easy-to-use clamping structure with a stable clamping effect.

2. Description of the Prior Art

To arrange the cleaning tools neatly and easily, a clamping device disclosed in TW Pat. No. 219099 was invented, as shown in FIG. 1, which comprises a seat 1 with a rack 101. Disposed on the rack 101 is a clamping member 11 with a gear wheel 111 having a central concave portion. The seat 1 and the clamping member 11 are disposed in a housing 12 which has a closed side and an open side, and the clamping member 11 can be appropriately exposed out of the open side. When an object a is to be positioned and clamped, it can be pushed into a clamping gap 13, consequently, the gear wheel 111 of the clamping member 11 is pushed to move along the rack 1011. At this moment, the clamping member 11 is caused to slightly press closely against the object a by a partial pressure. When the user releases the object a, the gravity of the object a, the friction of the clamping member 11 and the fact that the clamping member 11 is meshed with the rack 101 will make the clamping member 11 move toward the object a to produce a clamping effect, and thus the object a is fixed. To take out the object a, the user just needs to push it upward to drive the clamping member 11 backward so as to release the object. In practice, this structure still has the following problems:

When the object a is being clamped by the clamping member 11, the clamping member 11 only partially presses against the object a, which results in a unreliable clamping, namely, the clamping force of the clamping member 11 is inadequate, and the object a is likely to fall off in case of an impact. In addition, the structure is complicated and difficult to assemble since the clamping member 11 must be meshed with the rack 101.

The present invention has arisen to mitigate and/or obviate the afore-described disadvantages.

### SUMMARY OF THE INVENTION

The primary objective of the present invention is to provide a clamping structure which uses the simplest structural design to clamp the object stably and quickly.

To achieve the above objective, a clamping structure comprises: a pressing seat fixed on a wall; a housing disposed at one side of the pressing seat, a receiving space being formed in the housing, an opening being defined in a side of the housing facing the pressing seat, a slope being defined in a corner of the receiving space and located under the opening; a clamping member being movably disposed in the receiving space of the housing and partially contacting the slope. When its own gravity acts, the clamping member will partially be exposed out of the opening to press a to-be-clamped object against the pressing seat, so that the object is fixed without falling off.

### BRIEF DESCRIPTION OF THE DRAWINGS

FIG. 1 is a cross sectional view of a conventional clamping device;

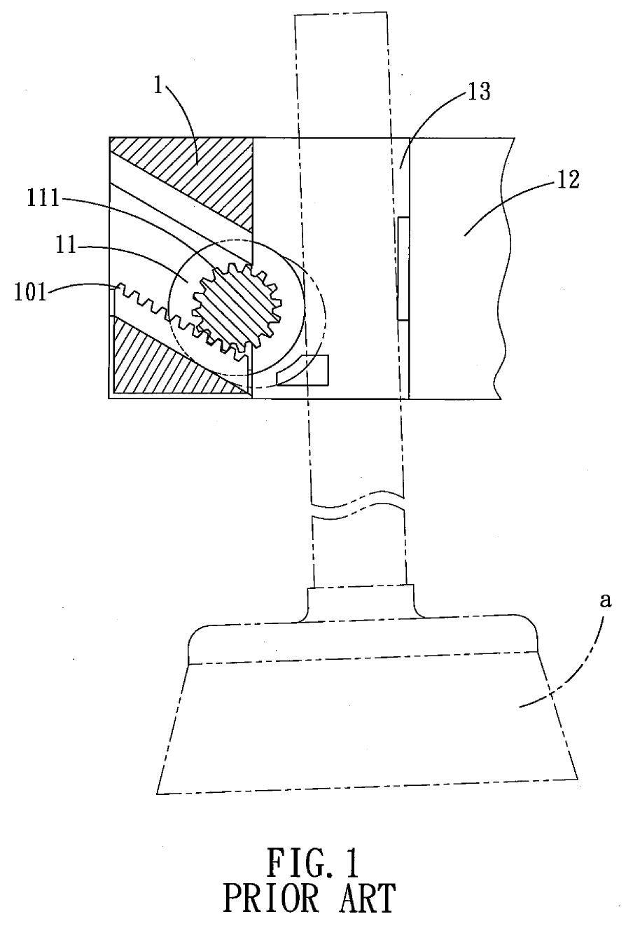

FIG. 2 is an exploded view of a clamping structure in accordance with the present invention;

FIG. 3 is a perspective view of showing the before-clamping state of the clamping structure in accordance with the present invention;

FIG. 4 is a perspective view of showing the clamping state of the clamping structure in accordance with the present invention;

FIG. 5 is a perspective view of the clamping structure in accordance with another embodiment of the present invention.

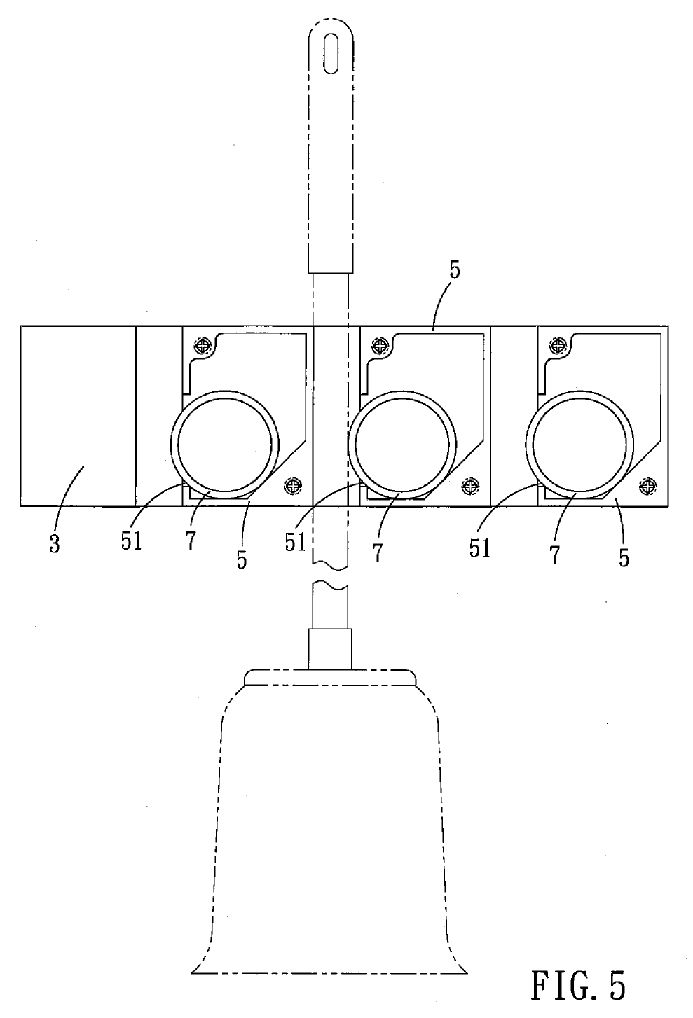

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

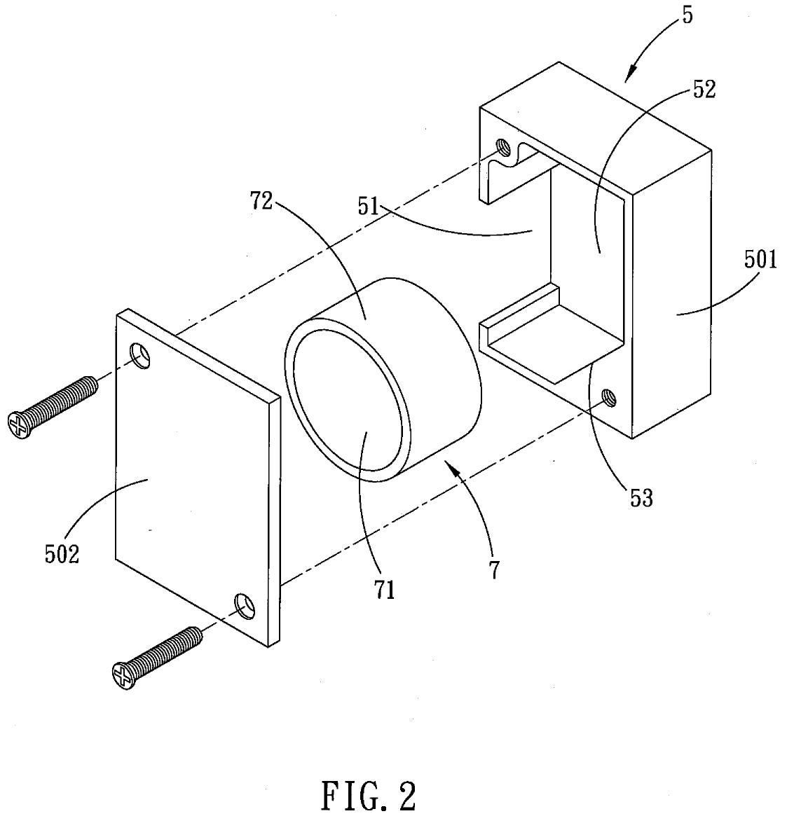

Referring to FIGS. 2-4, a clamping structure in accordance with the present invention comprises: a pressing seat 3, a housing 5 and a clamping member.

The pressing seat is fixed on the wall and located a distance from the housing 5 to form a clamping gap 31.

The housing 5 is disposed at one side of the clamping gap 31 of the pressing seat 3 and is defined with a receiving space 52. An opening 51 is formed in a side of the housing 5 facing the pressing seat 3. In the corner of the receiving space 52 is formed a slope 53 which is located under the opening 51. The housing 5 includes a rectangular hollow body 501 and a rectangular sheet-shaped cover 502.

The clamping member 7 with a certain weight is movably disposed in the receiving space 52 of the housing 5 and partially contacts the slope 53. When its own weight acts, the clamping member 7 can partially be exposed out of the opening 51 to press the object against the pressing seat 3, so that the object can be fixed without falling off. The clamping member 7 in accordance with the present invention includes a weight portion 71 and a friction portion 72 made of friction material, and the weight portion 71 is embedded in the friction portion 72.

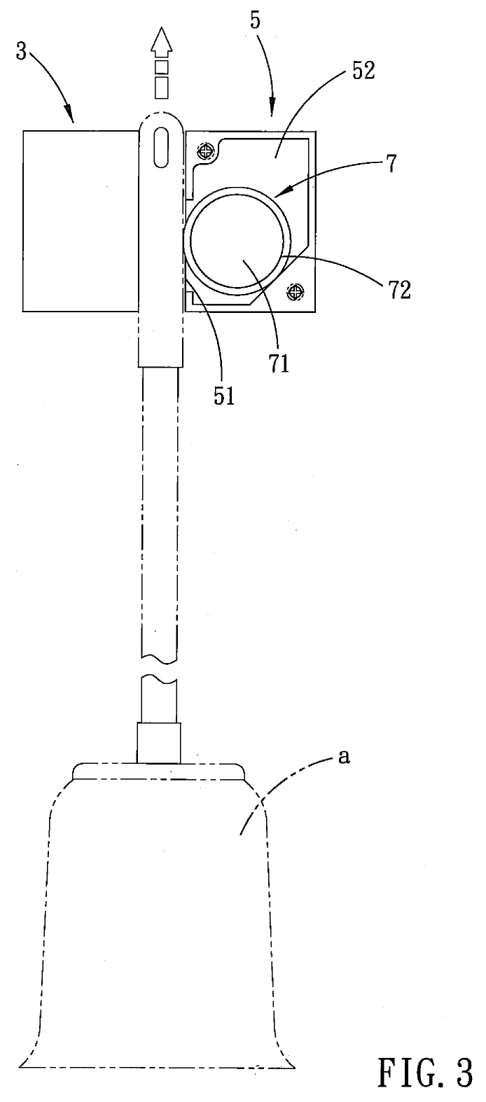

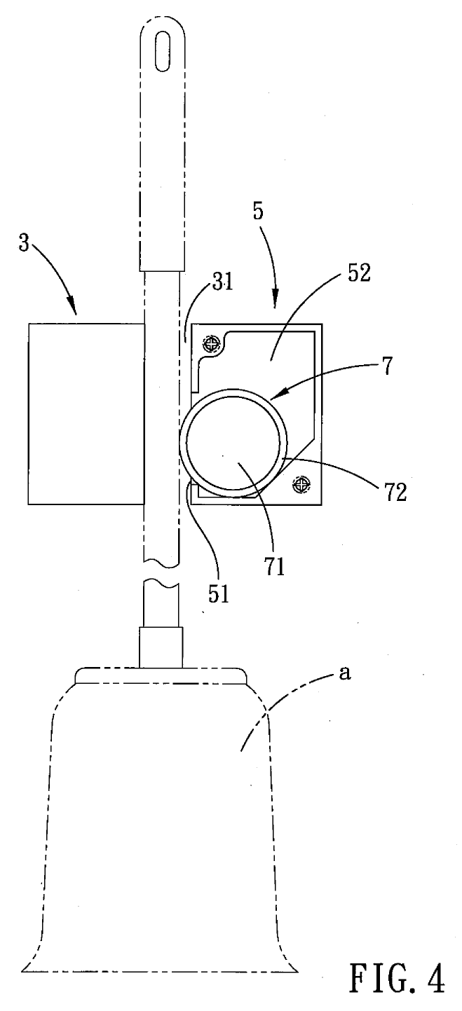

As shown in FIGS. 3 and 4, the housing 5 with the clamping member 7 is assembled at one side of the pressing seat 3 in such a manner that an appropriate clamping gap 31 is defined between the housing 5 and the pressing seat 3 for clamping the object a. When the user inserts the object a (let's take a mop as an example) in the clamping gap 31, the object a will push the clamping member 7 to move toward the slope 53, and afterwards, the clamping member 7 will move downward to press the object a against the pressing seat 3 under the influence of the gravity of the weight portion 71. Further, the friction portion 72 can increase the clamping force and make the clamping of the object more stable. The clamping member 7 and the pressing seat 3 cooperate with each other to clamp the object a. The object a can be taken out easily just with a slight upward pull. Hence, the clamping structure is simple in structure, and the object can be clamped and released easily and quickly, and most importantly, the object a can be clamped stably without the possibility of falling off.

It is noted that an additional housing 5 with the clamping member 7 can be separately fixed at the other side of the pressing seat 3, or a plurality of housings 5 can be connected to one another, and the clamping member 7 presses against the side of the respective housings 5 without the opening 51.

While we have shown and described various embodiments in accordance with the present invention, it is clear to those skilled in the art that further embodiments may be made without departing from the scope of the present invention.

What is claimed is:

1. A clamping structure comprising:
a pressing seat fixed on a wall and located a distance from a housing to form a clamping gap therebetween;
the housing disposed at one side of clamping gap of the pressing seat and defined with a receiving space, an opening being defined in a side of the housing facing the pressing seat, a slope being defined in a corner of the receiving space and located under the opening, the housing including a body and a cover; and
a clamping member with a predetermined weight being movably disposed in the receiving space of the housing and partially contacting the slope, when its own gravity acts, the clamping member will partially be exposed out of the opening to press a to-be-clamped object against the pressing seat, so that the object is fixed without falling off.

2. The clamping structure as claimed in claim 1, wherein the clamping member includes a weight portion and a friction portion made of friction material, and the weight portion is embedded in the friction portion.
